(19) United States
(12) Patent Application Publication
(10) Pub. No.: US 2008/0284782 A1
(43) Pub. Date: Nov. 20, 2008

(54) ELECTRONIC DISPLAY DEVICE AND METHOD FOR OPERATING A DISPLAY DEVICE

(75) Inventor: Harald Englerth, Wuerzburg (DE)

Correspondence Address: QUARLES & BRADY LLP, 411 E. WISCONSIN AVENUE, SUITE 2040, MILWAUKEE, WI, 53202-4497, US

(73) Assignee: NAVIGON AG, Hamburg (DE)

(21) Appl. No.: 12/022,229

(22) Filed: Jan. 30, 2008

(30) Foreign Application Priority Data
May 16, 2007 (DE) 10 2007 023 313.4

(51) Int. Cl. G06T 11/00

(52) U.S. Cl. 345/468

(57) ABSTRACT

A display device and a method for operating an electronic display device for displaying several characters in a character set, in particular for displaying letters and/or numbers. At least one character in the character set can be chosen by actuating a choosing device, and selected for further processing by actuating a selection device. The characters can be arranged and displayed on a curved line.

### CROSS-REFERENCE TO RELATED APPLICATION

This application claims the priority benefit of German Patent Application No. 10 2007 023 313.4 filed on May 16, 2007, the contents of which are hereby incorporated by reference as if fully set forth herein.

### STATEMENT CONCERNING FEDERALLY SPONSORED RESEARCH OR DEVELOPMENT

Not applicable.

### FIELD OF THE INVENTION

The present invention relates generally to a device and method for displaying several characters in a character set on an electronic display device, in particular, for displaying letters and/or numbers.

### BACKGROUND OF THE INVENTION

Generic display devices are used in a plurality of electronic devices, e.g., mobile phones, music players, portable minicomputers, DVD/video recorders, and digital cameras. In particular, such display devices are also provided in portable or built-in navigation devices.

Operating the devices often requires the entry of specific data, in particular the entry of letters and numbers. The characters to be entered are here displayed as a virtual keyboard in the display device in generic systems. Various concepts from prior art are known for displaying the characters on the display device.

DE 100 25 126 A1 describes a method for the character-by-character entry of a search term into a communication system of a motor vehicle. The character set present in this case, which comprises all letters of the alphabet and all Arabic numerals, is here displayed as a linear character stream. The disadvantage to displaying as a linear character stream is here that the end and the beginning of the character stream list are relatively far apart, so that the operator requires a corresponding amount of time for moving from the beginning of the list to the end of the list. In addition, a relatively large amount of space on the display device is needed for displaying the entire list, so that the character font has to be reduced in many instances in such display concepts.

DE 37 12 360 A1 also describes a method and device for selecting and entering the destination in a navigation system of a motor vehicle. The characters to be selected are here displayed as a function of certain probability criteria, wherein the characters to be displayed can be shown in horizontal and vertical character chains. The disadvantage to the display strategy described here is that it is not evident which letters are available for selection overall. In addition, intuitive use is impossible, since the user cannot discern the probability criteria.

EP 0 882 259 B1 describes an alphanumeric keyboard (ABC keyboard) in which the characters to be selected are arranged in lines and columns in a rectangular character field. The disadvantage to this type of display is that it precludes any intuitive character search, making it necessary to still look for letters and numbers even after the keyboard has been in use for a very long time. In addition, an intricate keyboard is required for selecting and choosing the characters.

### SUMMARY OF THE INVENTION

Proceeding from this prior art, the present invention provides a electronic display device for displaying several characters of a character set, in particular for displaying letters and/or numbers.

An embodiment of the present invention can be based upon the underlying idea of not arranging the characters to be displayed on a straight line as before in prior art, but rather along a curved line. This arrangement on a curved line can assist in intuitive use when selecting and choosing the characters. In addition, the space on the display device can be more effectively used.

The geometric shape of the curved line can in principle be as desired. Regular or irregular curved lines can be used. In an embodiment, the characters to be displayed are displayed on a circular line, in particular a closed circular line.

As an alternative to arranging the characters to be displayed on a circular line or a closed circular line, they can also be arranged on a spiral line. An advantage to this spiral arrangement can be that the characters each have more than two neighbors. These include the two adjacent characters in front of and behind the character on the spiral line. In addition, the characters lying on adjacent spiral line segments are also adjacent. Precisely given very large character sets, for example Japanese characters, the user can very quickly and intuitively go from one character to the next by either moving linearly along the spiral line or transversely between adjacent spiral line segments.

If the displayed character set is used for entering data in a device, for example for entering destination data in a navigation device, the desired characters must be sequentially selected to generate character chains to be entered. If the display device is designed as a touch-screen, selection can take place directly by touching the corresponding character. By contrast, if selection involves the use of corresponding actuators, for example keys, it can make sense to save on construction area by not allocating an actuator, e.g., a key, directly to each individual character. To make this possible, an upstream choosing device can precede the actual selection process. This means that a choosing device initially picks a character from the displayed character set. Choosing can here take place by pressing a rocker switch, for example. It can be particularly advantageous to highlight the respectively chosen character to show the user which character is currently picked. In particular rocker switches or joysticks are possible as choosing devices.

As soon as the chosen character in the character set matches the character desired by the user, a selection device, such as a pressure switch, can be actuated. Selection by means of the selection device takes the chosen character for further processing, and the next character can be chosen and then selected by actuating the selection device.

To further simplify the equipment outlay, it can be advantageous to combine the choosing device and selection device in a single switching element. In particular switches with a rotate-press mechanism have proven to be suitable. Rotating the switch first realizes the choosing device, while pressing the switch makes the selection.

The more characters contained in a single character set, the greater the maximum distance between two characters, which lengthens the maximum time for moving between two characters accordingly. To limit the maximum distance between two characters in a character set, it can be therefore advantageous to provide at least two mutually independent character sets. Actuating a changeover device then makes it possible to switch back and forth between the individual character sets.

Essentially any characters desired can be combined into the individual character sets. It can be advantageous for at least one character set to contain all letters of the alphabet, which can be in alphabetical order. A second character set can contain the Arabic numerals (0, 1, 2, 3, 4, 5, 6, 7, 8 and 9). Another character set can be provided for special characters, in particular umlauts.

Specific characters and functions can also be provided multiple times in the individual character sets. This can apply in particular for blank spaces for separating individual character chains from each other, or the delete function character. When actuated, the delete function character can make it possible to again delete a character in the character chain coming before or after it. In addition, the period character can be used to denote the end of a sentence and/or an @ character and/or a return character can appear repeatedly in the individual character sets as a confirmation character or line break. Other equivalent charters are also conceivable, of course. The characters used most frequently can appear in the various character sets, thereby forming an overlap between the character sets. As an alternative or in addition to the above, individual characters can also be repeatedly displayed in the individual character sets, so that these characters can be reached from any other character in the character set as quickly as possible.

In the simplest form, the various character sets can be each displayed individually and independently of each other. The capability of displaying the various character sets simultaneously can enable particularly quick and intuitive operation. To this end, the various character sets can in particular be arranged on concentric circles to make optimal use of the space present on the display device. The concentric arrangement here can offer an advantage similar to that of the spiral arrangement, in which the characters each have more than two neighbors. These are the two respective adjacent characters in front of and behind the character on the circular arc. In addition, the characters lying on the next closest internal and external character sets are also adjacent.

The display device can be used in substantially any kind of electronic system. The advantages to the display device can be advantageous for use with navigation systems, since the selection and/or entry of destinations that must take place when operating navigation systems can make it necessary to enter longer character chains. A display device according to an aspect of the invention can simplify the entry of these long character chains for describing the destination, for example the location name, the street name and the house number, and can facilitate an intuitive operation.

A display device according to another aspect of the invention can also exhibit a touch-sensitive surface, i.e., a type of touch-screen. By touching the surface in the area of a displayed character, this character can be directly selected, eliminating the need to choose the character beforehand. The touch-screen can also be combined with other actuators, for example, keys.

Another aspect of the present invention provides a method for operating the display device. The method can be based upon the underlying idea of arranging the character to be displayed on a curved line and displaying it in that way. In particular, the curved line can here be designed as a circular arc section, circular line or spiral line.

In order to intuitively simplify operation in devices in which a single actuator is not assigned to each character of the virtual keyboard, a choosing focus can be provided in an embodiment of the method. The choosing focus here always centers on a character, which is hence regarded as chosen, and can be selected by actuating another selection device. The choosing focus can be relatively moved over the characters in the character set by actuating the choosing device allocated to the choosing focus. The method can also provide for the choosing focus to remain on the same letter or always return to the first letter in the character set (e.g., A or 1) after a letter has been selected. The latter can be advantageous when the method includes involving a fixed choosing focus, since it achieves a system feedback to the user.

In an embodiment, it is not absolutely necessary to specially display the choosing focus. For example, a specific location on the display device can serve as the choosing focus, for example, always the character displayed at the very top. To make the choosing focus more recognizable, the respective chosen character can be highlighted on the display device. To this end, for example, a magnifying glass symbol can be superimposed, under which the chosen character is symbolically magnified.

To make the chosen character even more recognizable, the chosen character can also be displayed a second time. For example, if the displayed character set is circular, the respective currently chosen character can be superimposed in the middle of the circle once again.

Two different display strategies emerge as the choosing focus moves relative to the characters in the character set. In a first display strategy, the choosing focus can be fixed in place, and the characters in the character set are moved relative to the fixed choosing focus by actuating the choosing device. If several character sets are displayed simultaneously, for example as concentric circles, all character sets can either move concurrently, or only the activated character set is moved, while the others remain motionless. An advantage to the first variant can be that the vertically adjacent characters would always be identical. The second variant cab be advantageous in particular for cases where the character set jumps back to the initial position after the selection and incorporation of a character. This process can be advantageous, since the character used most frequently (e.g., period, space, comma, depending on application) generally appears first in the choosing focus upon activation of the character set ring of special characters, and can be selected without delay.

In the simple form, a jump from one respective character to the respective adjacent character can be initiated by actuating the selection device, for example, by pressing the key of a corresponding keyboard. As an alternative or in addition to the above, actuating the selection device can also be made to cause a specific number of characters to be jumped, and a correspondingly more remote character to be chosen. This can be advantageous in particular when various choosing devices can be made available. For example, it is conceivable in music players for the skip ahead keys to each symbolize individual jump jumps while choosing between the characters, while the fast forward or chapter skip keys each represent greater jumps over many characters.

In order to enable a quick and effective choosing of the various characters, it can be advantageous for the latter to be arranged in a closed annular structure. In other words, this means that the first character in the character set is adjacent to the last character in the character set. As a result, the choosing device can be activated to jump directly from the first character to the last character. This can considerably reduce the time required for choosing.

If the display device does not have enough space to show the entire character set, it is also possible to display only a respective portion of the character set. Arranging the characters on a curved line here can allow the user to intuitively recognize in which direction of the curved line he must continue moving, despite not seeing all characters in the character set. For example, if the characters in the character set are arranged on a circular ring, it can be frequently sufficient for intuitive operation for only a portion of the circular ring to actually be displayed, specifically a circular ring section of the character set. As an alternative, a fixed character set can be shown, and the choosing device is actuated to relatively move the movable choosing focus over the characters in the fixed character set. When displaying only a single circular ring segment, it is conceivable that a respective configurable buffer of characters can be defined in front of and behind the choosing focus. If the choosing focus approaches the borders of the displayed segment of the character set, the displayed segment of the character set can be advanced by one or more characters, so that a sufficient number of characters can again be shown in front of and behind the choosing focus. As a result, it can be ensured that the user will always recognize the next character(s) on the circular ring segment as the choosing focus moves.

The respectively displayed segment of the character set or positioning of the displayed characters in the character set can here be varied as a function of the respectively chosen character. This can help to ensure that at least the respective characters directly adjacent to the currently chosen character will be displayed.

The entry of character chains can also be simplified by comparing the chain with the already selected characters with character chains stored in a database, in particular with names of locations stored in a navigation device. These so-called “smart-spellers” then can ensure that only those characters in the character set that correspond to one of the character chains present in the database are chosen, thereby automatically precluding meaningless entries. The characters that cannot be chosen can be then usually highlighted in gray or otherwise visually deactivated. However, the unchoosable characters can also be shown in their entirety.

As an alternative or in addition, the so-called auto-completion routines can be integrated into a method according to an aspect of the invention. In these auto-completion routines, the chain of already chosen characters can be compared with character chains in a database, for example with names of locations stored in the navigation device. As soon as a sufficient correlation between the stored and selected characters emerges, the character chains stored in the database can be selected and automatically displayed.

The drawings schematically depict various embodiments of the invention, which will be described by example below.

### BRIEF DESCRIPTION OF THE DRAWINGS

FIG. 1 is a navigation device with electronic display device, wherein a first character set is schematically depicted from above;

FIG. 2 is the navigation device according to FIG. 1, wherein the first character set is displayed in a modified display mode;

FIG. 3 is the navigation device according to FIG. 2, in the same display mode with the character set in an altered position;

FIG. 4 is the navigation device according to FIG. 1, wherein a second character set is displayed;

FIG. 5 is the navigation device according to FIG. 1, wherein the first and second character sets are displayed simultaneously;

FIG. 6 is the navigation device according to FIG. 1, wherein the first character set is displayed in another display mode;

FIG. 7 is the navigation device in the display mode according to FIG. 6, wherein another character is chosen;

FIG. 8 is the navigation device in the display mode according to FIG. 7, wherein another character is chosen;

FIG. 9 is the navigation device according to FIG. 1, wherein the first character set is displayed in another display mode;

FIG. 10 is the navigation device in the display mode according to FIG. 9, wherein another character is chosen; and

FIG. 11 is the navigation device according to FIG. 1, wherein another character set is displayed.

### DETAILED DESCRIPTION OF THE EXAMPLE EMBODIMENTS

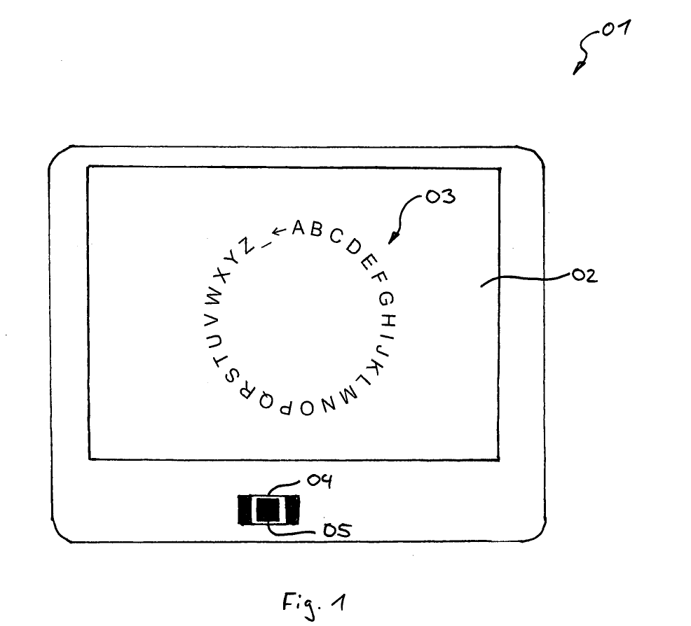

FIG. 1 shows a navigation device 01 with a display device 02, for example an LCD display. A virtual keyboard with a first character set 03 can be displayed on the display device 02. The character set 03 here encompasses the alphabet in alphabetic order from A to Z, the space and an arrow symbol for the delete function. The individual characters in the character set 03 are here depicted in such a way that they lie on a closed circular line. In addition, the characters in the character set 03 form a closed annular structure, in which the first character in the character set, specifically the A, lies next to the last character in the character set, specifically the arrow symbol for the delete function.

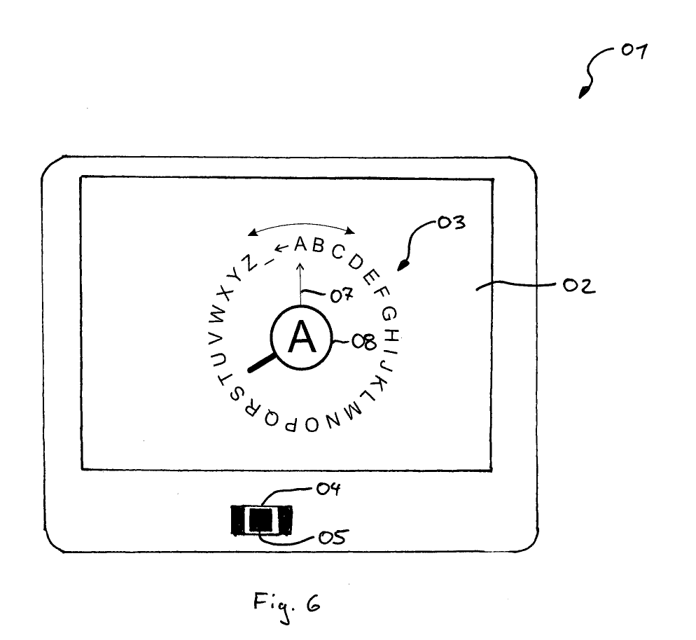

A rocker switch 04 and pushbutton 05 are used to select the individual characters in the character set 03 while entering character chains, in particular while entering destination data. The procedure for selecting individual characters from the character set 1 will be explained in greater detail later based on FIGS. 6 to 10.

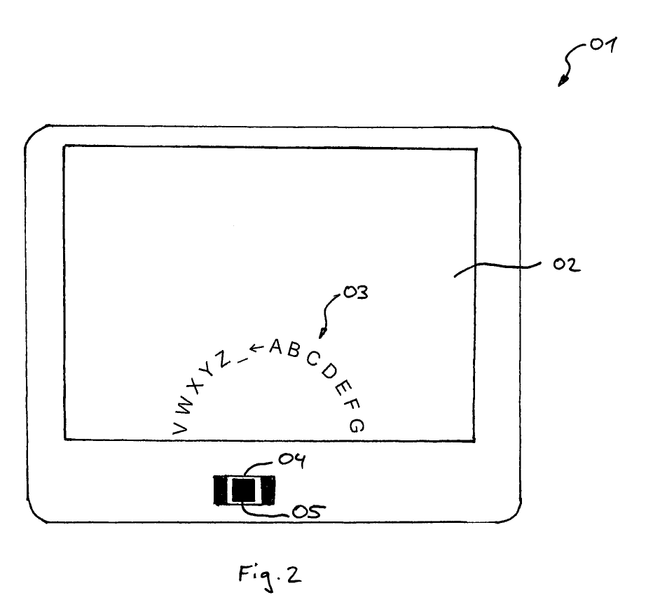

FIG. 2 shows the navigation device 01 while displaying the character set 03 in a modified display mode. Only half the character set 03 is displayed in a semicircle in this display mode. The position of the displayed character set 03 changes as a function of the respectively chosen character in the character set 03. If character A is chosen, as depicted in FIG. 2, the characters adjacent to character A on the right and left are displayed in the semicircle.

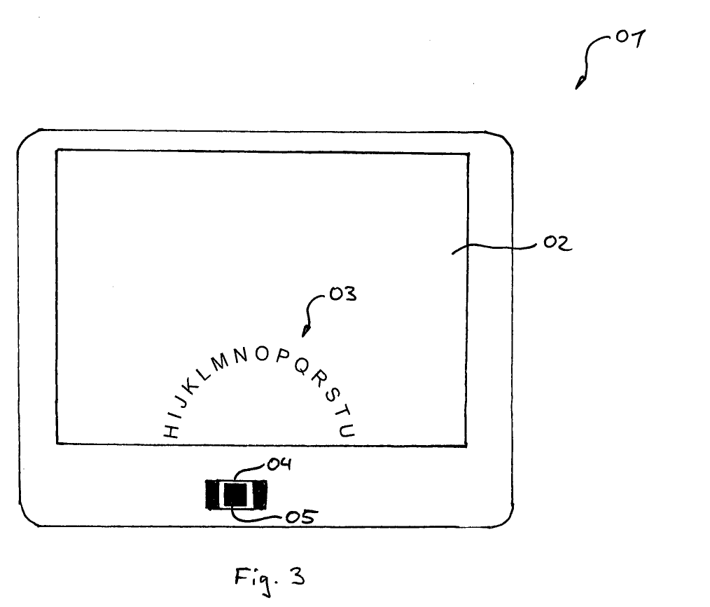

By contrast, if the character O is chosen as depicted in FIG. 3, all characters adjacent to the O in the semicircle are displayed.

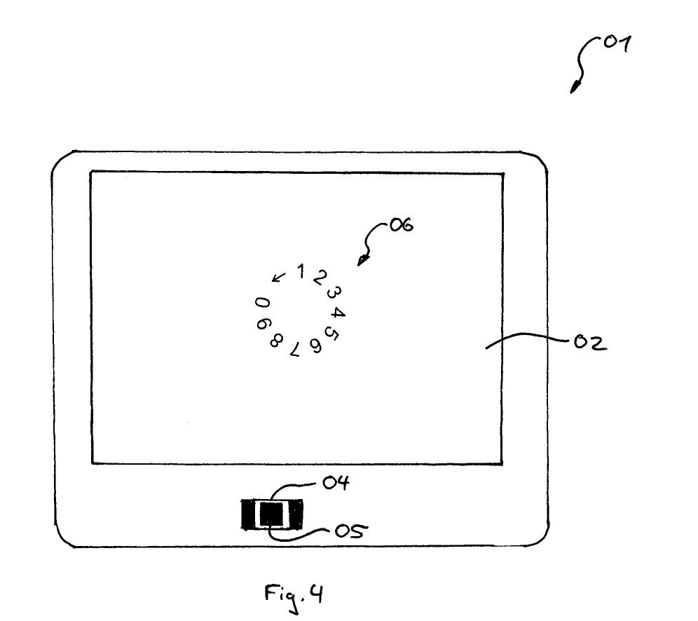

FIG. 4 shows the navigation device 01 while displaying a second character set 06 on the display device 02. The second character set 06 encompasses the Arabic numerals 0 to 9, and the character for the delete function.

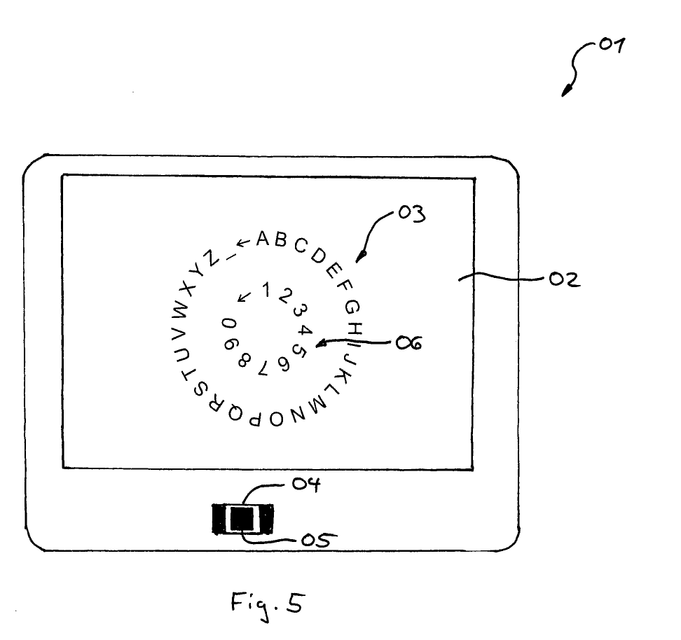

FIG. 5 shows the navigation device 01 in another display mode. In this display mode, the character sets 03 and 06 are simultaneously displayed arranged as concentric circles. For example, a corresponding key combination of switches 04 and 05 can be used to switch between the two character sets 03 and 06.

The depictions in FIGS. 6, 7 and 8 will be used below to describe the entry of a character chain, specifically the location name Ansbach. In the display mode shown in FIG. 6 to FIG. 8, a fixed choosing focus is provided, which is respectively situated at the highest point of the circular line formed by the character set 03, and is symbolized by a signal arrow 07. The character in the choosing focus, i.e., the A in the display shown in FIG. 6, is regarded as chosen, and is again magnified to highlight this choice in the midpoint of the circular ring. A magnifying glass symbol 08 is provided to illustrate this magnification. When entering the location Ansbach, the A is first moved into the choosing focus. To this end, the pushbuttons of the rocker switch 04 are pressed, wherein the character set 03 rotates counterclockwise when the left key of the rocker switch is pressed 04, and the character set 03 rotates clockwise when the right key of the rocker switch 04 is pressed. As soon as the A is in the choosing focus as shown in FIG. 6, the A can be selected by pressing the pushbutton 05, and relayed to further processing.

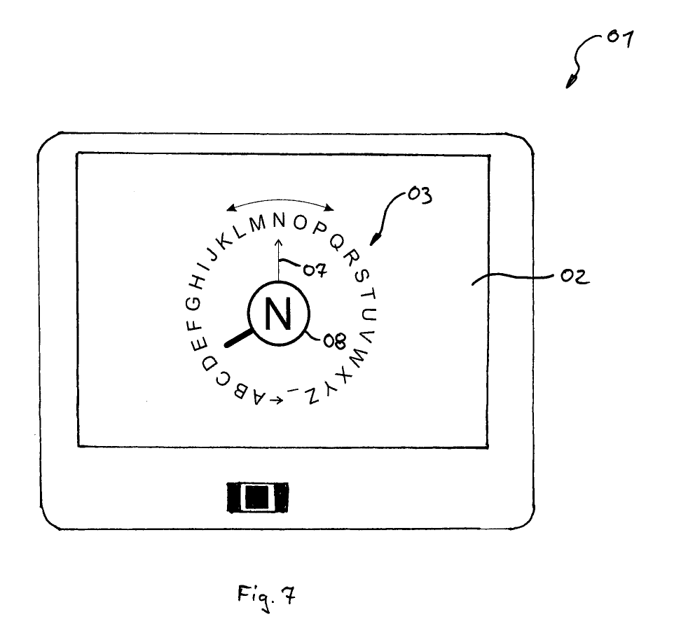

In FIG. 7, the character set 03 is then turned by actuating the rocker switch 04 until N is in the choosing focus, and the latter is selected by pressing the pushbutton 05.

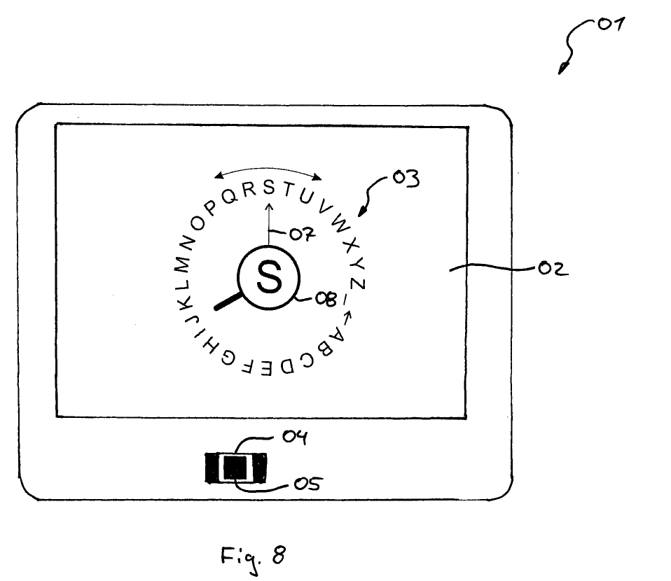

As illustrated in FIG. 8, the S is then brought into the choosing focus and selected. As soon as all letters in the destination Ansbach have been selected in this way, the character chain can be adopted for further processing, and corresponding processing routines can be initiated.

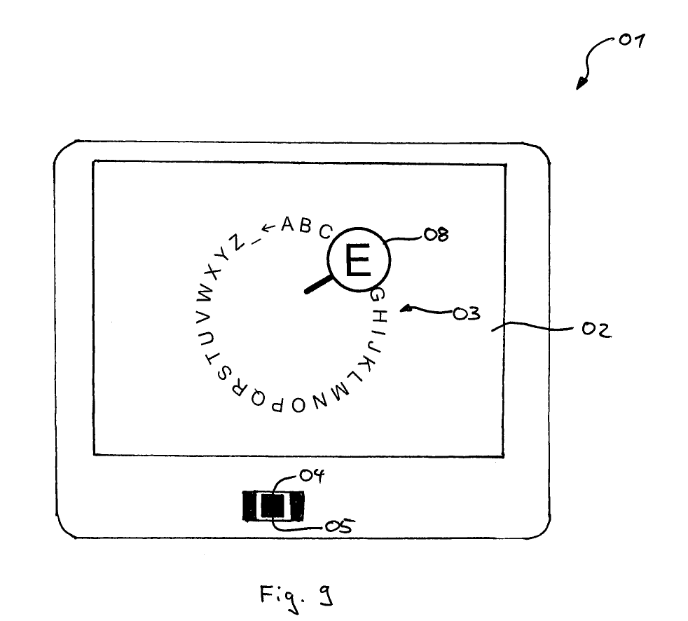

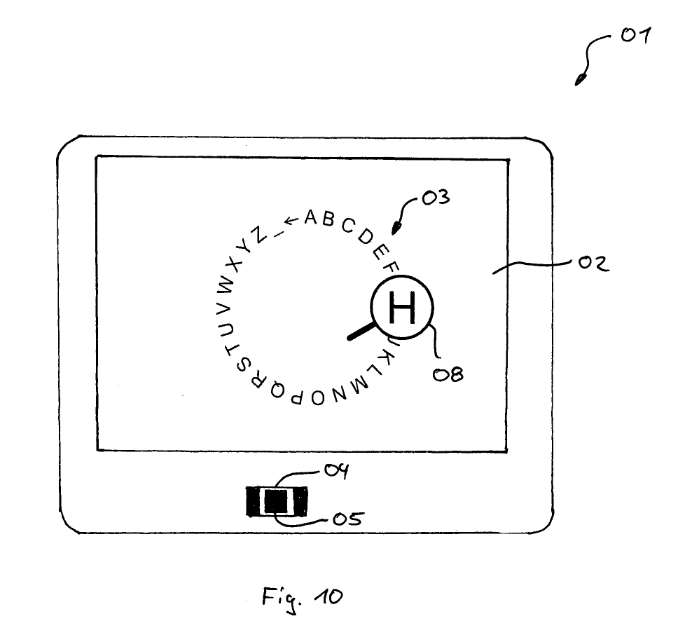

FIG. 9 and FIG. 10 present an alternative display mode. In this display mode, the character set 03 is displayed in a fixed state, and the choosing focus symbolized by the magnifying glass symbol 08 is moved over the characters of the fixed character set 03 by actuating the rocker switch 04.

In order to obtain the display shown in FIG. 10, the right key of the rocker switch 04 is pressed three times, thereby shifting the magnifying glass symbol 08 three characters in the clockwise direction.

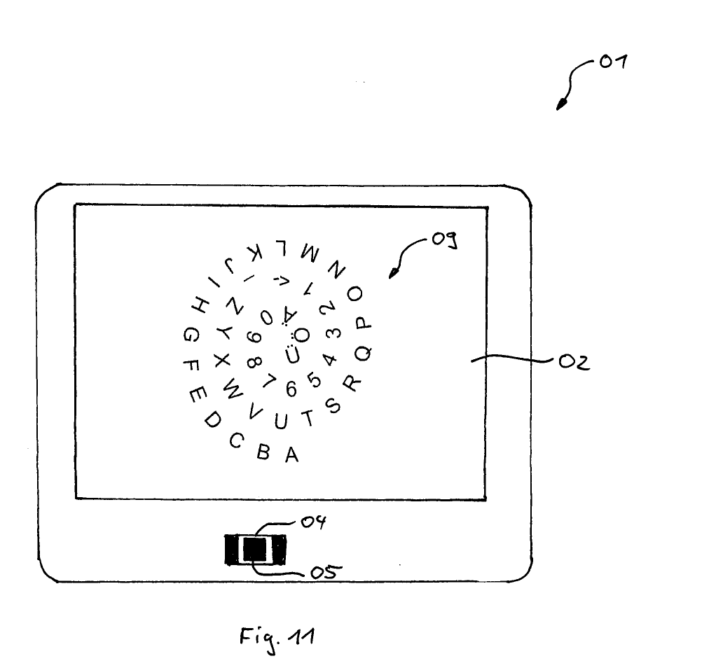

FIG. 11 shows the navigation device 01 while displaying a character set 09 that contains the alphabet, Arabic numerals and various special characters. The character set 09 is here arranged on a spiral line, making it possible to utilize more of the space on the display device 02.

I claim:

1. An electronic display device for displaying several characters in a character set, in particular for displaying letters and/or numbers, wherein the characters displayed on the display device are arranged on a curved line.

2. The display device according to claim 1, wherein the curved line forms a circular arc segment, in particular a closed circular line.

3. The display device according to claim 1, wherein the curved line forms a spiral line.

4. The display device according to claim 1, wherein at least one character in the character set can be chosen by actuating a choosing device.

5. The display device according to claim 4, wherein the respectively chosen character in the character set is highlighted, in particular magnified, in a magnifying glass symbol.

6. The display device according to claim 4, wherein the choosing device is designed as a type of rocker switch or a type of joystick.

7. The display device according to claim 4, wherein the chosen characters in the character set can be selected for further processing by actuating a selection device.

8. The display device according to claim 7, wherein the choosing device and selection device are combined to form a type of switch with a rotate-press mechanism.

9. The display device according to claim 1, wherein at least two character sets are provided, wherein a changeover device can be actuated to switch between the different character sets.

10. The display device according to claim 1, wherein a first character set comprises the letters of the alphabet, in particular arranged in alphabetic order, and/or a second character set comprises the Arabic numerals, in particular arranged in ascending order, and/or a third character set comprises special characters, in particular umlauts.

11. The display device according to claim 1, wherein at least two character sets each comprise the same respective characters, in particular a blank apace and/or a character for the delete function and/or a period character and/or an @ character and/or a return character.

12. The display device according to claim 1, wherein a character set repeatedly comprises a respective identical character, in particular a blank apace and/or a character for the delete function and/or a period character and/or an @ character and/or a return character.

13. The display device according to claim 1, wherein the various character sets can be displayed simultaneously, in particular arranged on concentric circles.

14. The display device according to claim 1, wherein the display device is a component of a navigation device and the display device can be used in particular for selecting and/or entering a destination.

15. The display device according to claim 1, wherein the display device exhibits a touch-sensitive surface and wherein touching the surface in the area of a displayed character makes it possible to select this character.

16. A method for operating an electronic display device for displaying several characters in a character set, in particular for displaying letters and/or numbers, wherein at least one character in the character set can be chosen by actuating a choosing device and selected for further processing by actuating a selection device, and wherein the characters are arranged and displayed on a curved line.

17. The method according to claim 16, wherein the characters are displayed lying on a circular arc segment, in particular on a closed circular line.

18. The method according to claim 16, wherein the characters are displayed lying on a spiral line.

19. The method according to claim 16, wherein a choosing focus is present, which flags the respectively chosen character in the character set, wherein actuating the choosing device relatively moves the choosing focus over the characters in the character set.

20. The method according to claim 19, wherein the respectively chosen character is highlighted, in particular magnified, in a magnifying glass symbol.

21. The method according to claim 19, wherein the respectively chosen character is additionally displayed a second time, in particular in the middle of the circularly displayed character set.

22. The method according to claim 16, wherein the choosing focus is fixed in place, and the characters in the character set are together moved relative to the fixed choosing focus by actuating the choosing device.

23. The method according to claim 22, wherein the choosing focus is fixed in place, and the characters of all concentrically arranged character sets are together moved relative to the fixed choosing focus by actuating the choosing device.

24. The method according to claim 22, wherein the choosing focus is fixed in place, and the characters in the character set selected with the changeover device and which in particular is concentrically arranged, are together moved relative to the fixed choosing focus by actuating the choosing device, while the other, in particular concentrically arranged character sets which have not been selected with the changeover device are shown fixed in place.

25. The method according to 19, wherein the character set is shown fixed in place, and the choosing focus is relatively moved over the characters in the fixed character set by actuating the choosing device.

26. The method according to claim 19, wherein the respective character immediately adjacent or remote by a specific number of characters is chosen in the character set by actuating the choosing device.

27. The method according to claim 16, wherein the characters in the character set form a closed annular structure, wherein the first character in the character set in the annular structure is adjacent to the last character in the character set.

28. The method according to claim 16, wherein only a portion of the characters in the character set is displayed, in particular that several characters arranged on a circular ring section are displayed, which belong to a character set arranged on a closed circular ring.

29. The method according to claim 28, wherein the displayed portion of characters in the character set and/or positioning of the displayed characters in the character set are changed as a function of the chosen character.

30. The method according to claim 29, wherein the ends of the displayed portion of the characters arranged in particular in a circular ring section are respectively provided with a presentation buffer, wherein, with the choosing focus situated in the presentation buffer, the displayed portion of the characters arranged in a circular ring section is shown being moved counterclockwise by one or more characters.

31. The method according to claim 16, wherein the chain of already selected characters is compared with a character chain in a database, in particular with location names stored in a navigation device, wherein only the characters in the character set that correspond to a character chain present in the database can subsequently be chosen.

32. The method according to claim 16,
characterized in that
the chain of already selected characters is compared with a character chain in a database, in particular with location names stored in a navigation device, wherein all character chains stored in the database that sufficiently match the chain of already selected characters are automatically displayed.
